(19) United States
(12) Patent Application Publication
(10) Pub. No.: US 2016/0366520 A1
(43) Pub. Date: Dec. 15, 2016

(54) Miniature Sound Generator

(71) Applicants: Kaihua Shen, Shenzhen (CN); Zhiwei Zhong, Shenzhen (CN)

(72) Inventors: Kaihua Shen, Shenzhen (CN); Zhiwei Zhong, Shenzhen (CN)

(73) Assignee: AAC Technologies Pte. Ltd., Singapore City (SG)

(21) Appl. No.: 15/004,984

(22) Filed: Jan. 24, 2016

(30) Foreign Application Priority Data
Jun. 12, 2015 (CN) 201520406754.7

(51) Int. Cl. H04R 9/02; H04R 9/06

(52) U.S. Cl. CPC H04R 9/025; H04R 9/06; H04R 2209/024; H04R 2499/11

(57) ABSTRACT

A miniature sound generator is disclosed. The miniature sound generator includes: a vibration system; a magnetic circuit system including a permanent magnet accommodated in a magnetic bowl and a pole piece located on the permanent magnet; and a housing for accommodating and fixing the vibration system. The permanent magnet includes a first through-hole, the pole piece has a second through-hole, and the magnetic bowl includes a blind hole.

### FIELD OF THE INVENTION

The present disclosure relates to sound generators, more particularly to a miniature sound generator used in portable electronic devices.

### DESCRIPTION OF RELATED ART

Miniature sound generators are used widely in mobile phones, laptop computers and other portable electronic devices. Along with the rapid development of portable electronic devices, the requirement on function is increasingly higher. The miniature sound generators used in these devices are developed fast correspondingly.

The miniature sound generator 2′ in relevant structure is shown in FIG. 1, and includes a lower housing 21, a magnetic bowl 22′ installed in the lower housing 21′, a permanent magnet 23′ in the magnetic bowl 22′, a voice coil 24′ installed in the magnetic gap formed by the permanent magnet 23′ and the magnetic bowl 22′, a vibrating diaphragm 25′ connected to the voice coil 24′, an upper housing 26′ connected to the lower housing 21′, and a metal sheet 27′ accommodated in the lower housing 21′. The voice coil 24′ is connected electrically by the metal sheet 27′. When alternative voice frequency current passes through the voice coil, the voice coil 24′ driven by alternative forces in the magnetic gap moves alternatively and drives the vibrating diaphragm 25′ to vibrate, thereby makes sound. In order to improve the performance of products, the voice coil used in the miniature moving coil sound generator is made generally in runway shape or rectangular shape.

Chinese patent No. “03222994.1” discloses a miniature sound generator. The magnetic circuit system is composed of a magnet frame, a magnet and a pole piece. The magnet and pole piece in this invention are in complete plate structure. When adjusting the cavity resonance of the speaker unit itself, middle, low and high frequency response is big, the acoustic performance is influenced.

Chinese patent application number “201420153765.4” discloses a miniature sound generator and a vibrating diaphragm. Its internal magnetic circuit system is composed of a magnetic bowl, a magnet and a washer. The magnet and the washer in this invention are in complete plate structure. When adjusting the cavity resonance of the speaker, middle, low and high frequency response is big. The acoustic performance is influenced thereby.

Therefore, it is necessary to provide a new miniature sound generator to overcome the problems mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric exploded view of a related miniature sound generator.

FIG. 2 is an isometric exploded view of a miniature sound generator in accordance with a first embodiment of the present disclosure.

FIG. 3 is an isometric exploded view of the miniature speaker in FIG. 2, from another aspect.

FIG. 4 is an isometric assembled view of the miniature sound generator.

FIG. 5 is a cross-sectional view of the miniature sound generator.

FIG. 6 is a front view of a vibrating diaphragm of the miniature sound generator.

FIG. 7 is an isometric view of a magnetic circuit system of the miniature sound generator.

FIG. 8 is a cross-sectional view of a miniature sound generator in accordance with a second embodiment of the present disclosure.

FIG. 9 is a cross-sectional view of a miniature sound generator in accordance with a third embodiment of the present disclosure.

FIG. 10 is a cross-sectional view of a miniature sound generator in accordance with a fourth embodiment of the present disclosure.

FIG. 11 is an isometric view of a magnetic circuit system of the miniature sound generator of the second embodiment.

FIG. 12 is an isometric view of a magnetic circuit system of the miniature sound generator of the fourth embodiment.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of present disclosure more apparent, the present disclosure is described in further detail together with the figures and the embodiments. It should be understood the specific embodiments described hereby is only to explain this disclosure, not intended to limit this disclosure.

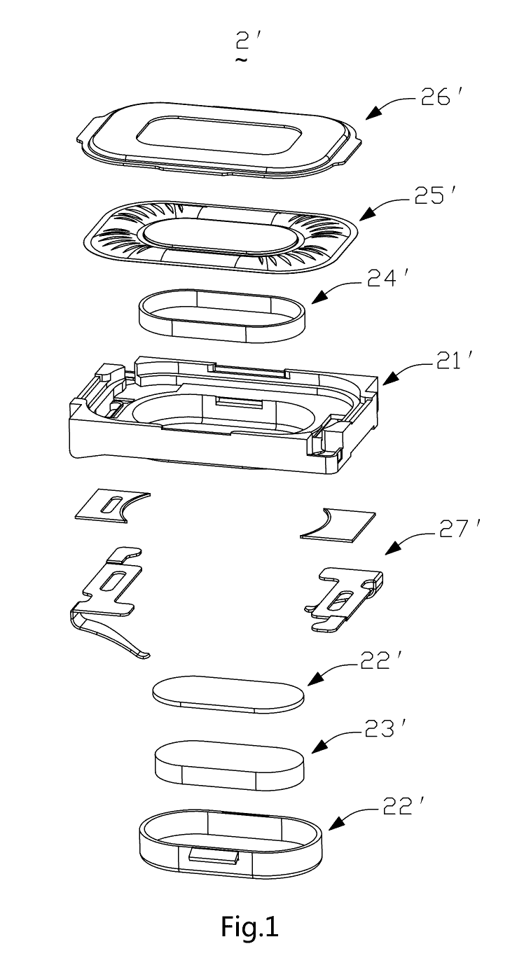

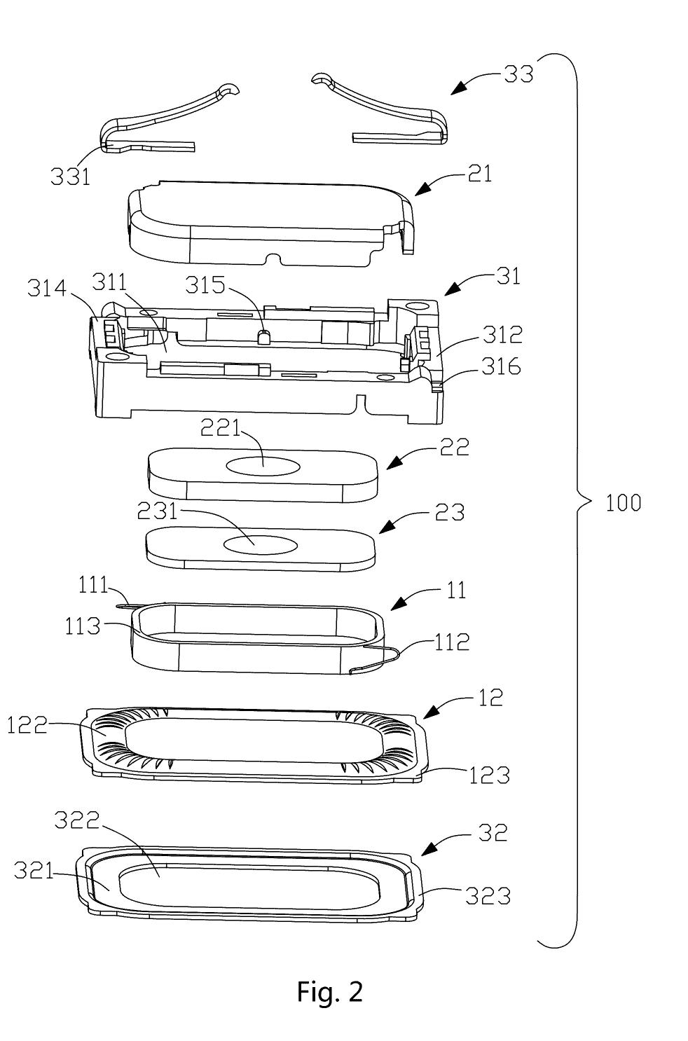

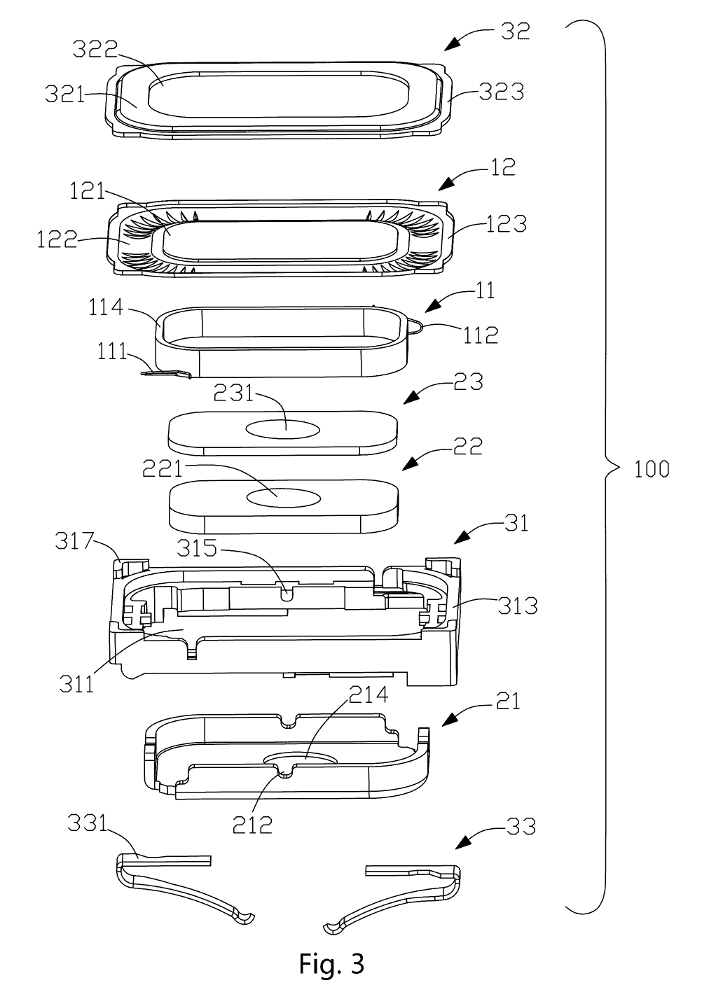

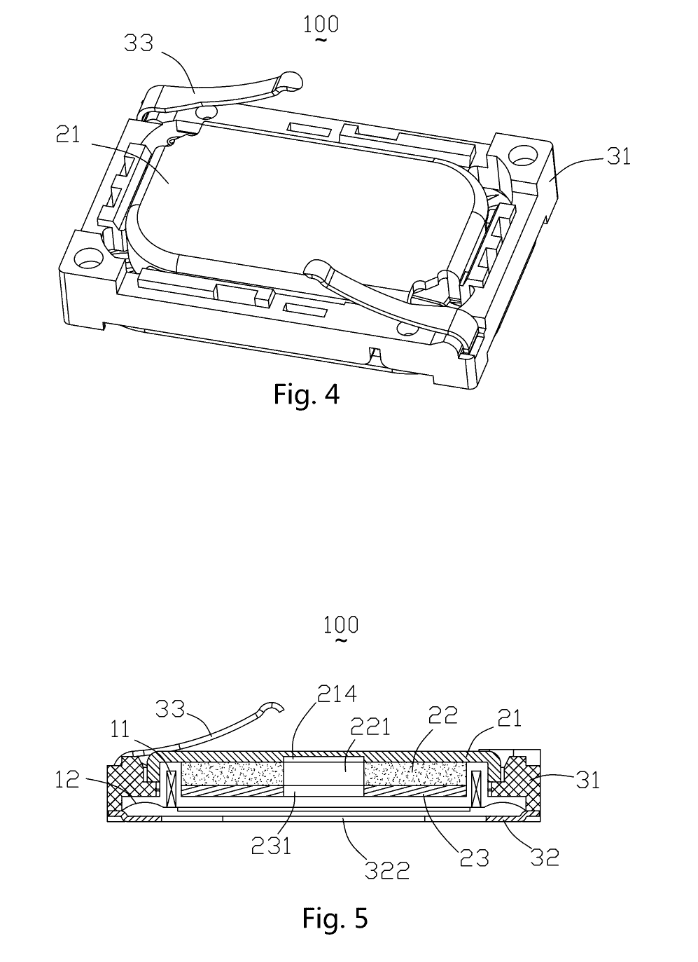

As shown in FIGS. 1-12, a miniature sound generator 100 in accordance with a first embodiment of the present disclosure includes a vibration system, a magnetic circuit system and au auxiliary system. The vibration system includes a voice coil 11 and a vibrating diaphragm 12 which is attached to the voice coil 11. The magnetic circuit system includes a magnetic bowl 21, a permanent magnet 22 and a pole piece 23 which are accommodated in the magnetic bowl 21. The auxiliary system includes a frame 31, an upper cover 32 and a conducting strip 33.

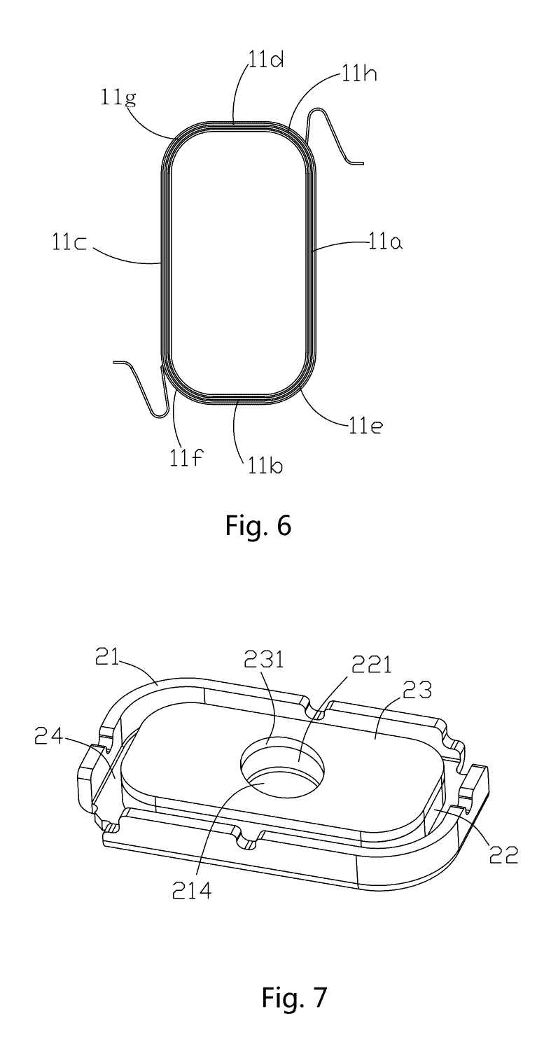

As shown in FIG. 6, the voice coil 11 is made of enameled metal wires wrapped continuously, and provided with an inlet wire 111 and an outlet wire 112, also includes a front side 113 away from the vibrating diaphragm 11 and a back side 114 near the vibrating diaphragm. The inlet wire 111 and the outlet wire 112 are located at the front side 113 of the voice coil 11. The back side 114 of the voice coil 11 is connected by adhesive to the vibrating diaphragm 11. As shown in FIG. 5, the voice coil 11 is composed of four straight sections, 11a, 11b, 11c and 11d, as well as four arc sections 11e, 11f, 11g and 11h which are connected smoothly to four straight sections. The arc radius is 0.3 mm and arc angle is 90°, meanwhile, the radius can also be 0.35 mm, 0.38 mm or 0.4 mm.

The vibrating diaphragm 12 includes a flat top 121 and a soft edge 122 with flat center, in which, the flat top 121 is located at the soft edge 122. The vibrating diaphragm 12 is installed on the frame 31 by a positioning basket 123 which fixes the side of the soft edge 122. The shape of the flat top 121 and the soft edge 122 is as same as the shape of the voice coil 11.

The magnetic bowl 21, the permanent magnet 22 and the pole piece 23 accommodated in the magnetic bowl 21 create a magnetic gap 24 to accommodate the voice coil 11. As shown in FIG. 6, the shape of the magnetic gap 24 is as same as the shape of the voice coil 11.

The frame 31 is a hollow cuboid part and is composed of an annular receiving hole 311 and a main body 312 surrounding the annular receiving hole 311. The main body 312 is composed of an upper surface 313 and a lower surface 314 relative to the upper surface 313. The inner surface of the main body 312 is provided with a dowel pin 315. The magnetic bowl 21 is installed in the receiving hole 311 of the frame 31 by inserting the draw pin 315 into a mortise 212. The opening of the magnetic bowl 313 faces the upper surface 313. Two corners on the lower surface 314 of the main body 312 are provided with a slot 316. Four corners of the upper surface 313 are respectively provided with four stoppers 317 for fixing an upper cover 32.

The upper cover 32 is made of metal plate and is provided with a sound hole 322 and a flat part 321 around the sound hole 322. Two ends of the flat part 321 are extended outward and provided with a locking part 323. The locking part 323 can be fixed on the stopper 317 on the main body 312.

A conducting strip 33 is made by metal plate with one end bent into a hook 331. The conducting strip 33 is installed on the frame 31 by connecting the hook 331 to the slot 316 on the frame 31. The conducting strip 33 is connected electrically to the inlet wire 111 and outlet wire 112 of the voice coil 11.

In the miniature sound generator of this structure, when alternative voice frequency current passes through the voice coil 11 by the conducting strip 33, the voice coil 11, driven by alternative forces in the magnetic gap 24, moves alternatively. The vibrating diaphragm 12 vibrates thereby and makes sound.

As shown in FIGS. 5 and 7, the magnetic circuit system includes a magnetic bowl 21, and a permanent magnet 22 and a pole piece 23 accommodated in the magnetic bowl 21. The permanent magnet is provided with the first through-hole 221. The pole piece is provided with the second through-hole 231. The first through-hole 221 and the second through-hole 231 are located respectively at the center of the permanent magnet and the pole piece. The first through-hole 221 and the second through-hole 231 are in same size. The first through-hole 221 and the second through-hole 231 are cylindrical. The first through-hole 221 and the second through-hole 231 are coaxial. The first through-hole 221 and the second through-hole 231 penetrate respectively through the permanent magnet 22 and the pole piece 23 in thickness direction of the permanent magnet 22 and the pole piece 23. At the same time, a blind hole 214 is provided at the inner side of the magnetic bowl 21 corresponding to the first through-hole 221. The blind-hole 214 and the first through-hole 221 are in same size and cylindrical. The blind hole 214 and the first through-hole 221 are coaxial. The depth of the blind hole 214 is half of the thickness of the magnetic bowl 21.

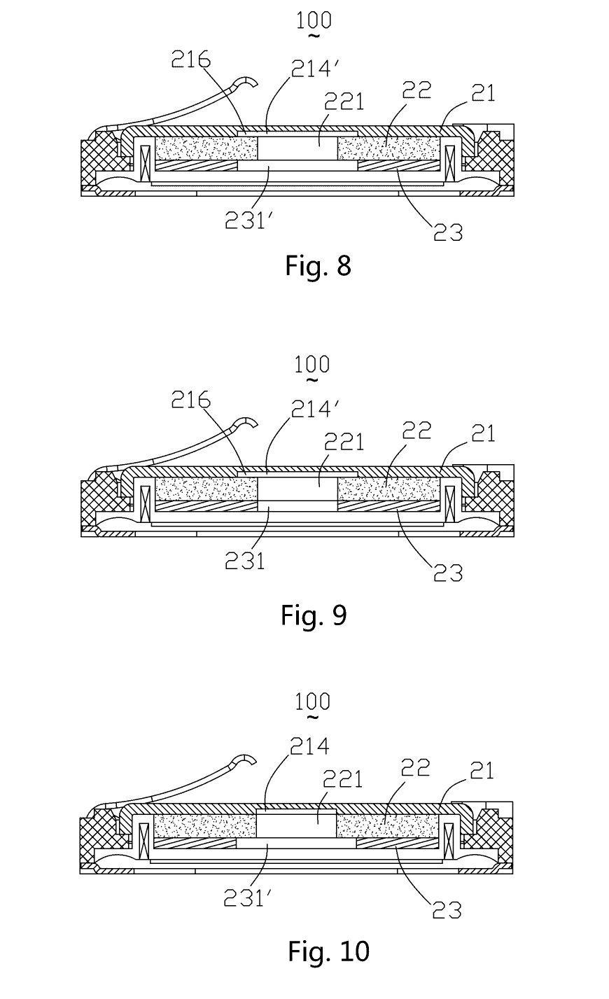

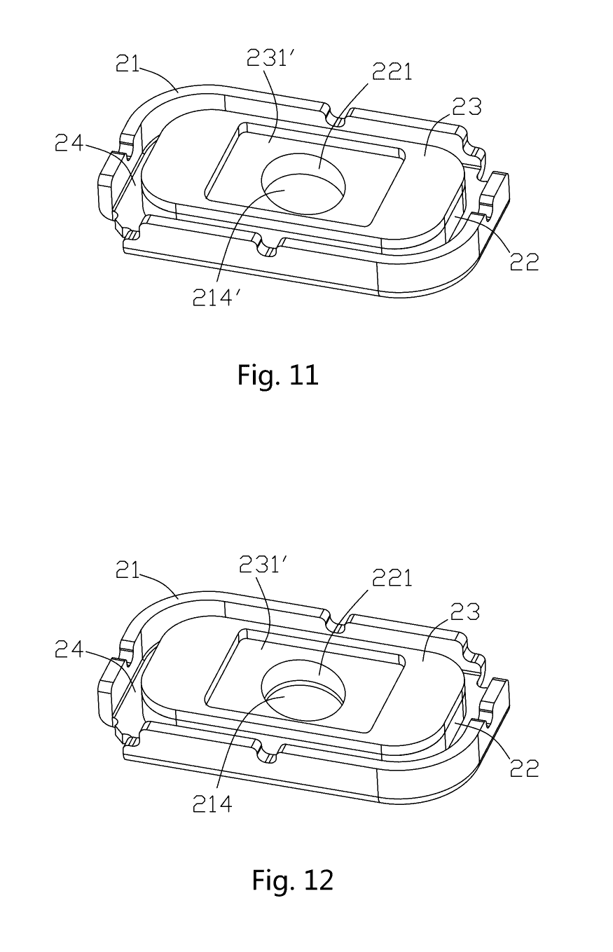

In a second embodiment shown in FIG. 8 and FIG. 11, the aperture of the blind hole 214 on the magnetic bowl 21 and the aperture of the second through-hole 231 on the pole piece 23 are larger than the aperture of the first through-hole 221 on the permanent magnet 22. The first through-hole 221, the second through-hole 231 and the blind hole 214 can be made in any shape and in different shape. As the aperture of the blind hole 214 is not smaller than the aperture of the first through-hole 221, therefore, a cavity 216 between the magnetic bowl 21 and the permanent magnet 22 can improve high frequency response.

In a third embodiment shown in FIG. 9, the aperture of the blind hole 214 on the magnetic bowl 21 is larger than the aperture of the first through-hole 221 on the permanent magnet 22. The first through-hole 221, the second through-hole 231 and the blind hole 214 can be made in any shape and in different shape. As the aperture of the blind hole 214 is bigger than the aperture of the first through-hole 221, therefore, a cavity 216 between the magnetic bowl 21 and the permanent magnet 22 can improve high frequency response.

In a fourth embodiment shown in FIG. 10 and the FIG. 12, the aperture of the second through-hole 231 on the pole piece 23 is bigger than the aperture of the first through-hole 221 on the permanent magnet 22. The first through-hole 221, the second through-hole 231 and the blind hole 214 can be made in any shape and in different shape.

In the magnetic circuit system of this invention, the through-hole is provided at the center of the permanent magnet 22 and the pole piece 23. A blind hole 214 is provided at the inner side of the magnetic bowl 21 corresponding to the first through-hole 221. Under circumstances to keep the structure and size of the permanent magnet 22 and the pole piece 23 unchanged, the magnetic circuit system of this invention can improve product performance. Compared with the permanent magnet and the pole piece in traditional magnetic circuit system, the magnetic circuit system of this invention adjusts only the cavity resonance of the speaker unit itself, improves effectively high frequency response thereby, but has little influence on low and middle frequency response, and is simple in structure.

The miniature sound generator in this disclosure includes a vibration system, a magnetic circuit system, as well as a housing for accommodating and fixing the vibration system and the magnetic circuit system. The magnetic circuit system includes a magnetic bowl, a permanent magnet and a pole piece which are accommodated in the magnetic bowl. The first cavity is provided on the permanent magnet and the pole piece. The magnetic bowl inside is provided with a blind hole. The aperture of the blind hole is bigger than the aperture of the first cavity. The second cavity is formed between the magnetic bowl and the permanent magnet. The second cavity and the first cavity are connected.

Compared with the permanent magnet and the pole piece in the existing magnetic circuit system, in this invention, the first cavity is provided on the permanent magnet and the pole piece, and the second cavity is formed between the magnetic bowl and the permanent magnet. The second cavity and the first cavity are connected. The magnetic circuit system in this invention adjusts only the cavity resonance of the speaker unit itself, improves effectively high frequency response, has little influence on low and middle frequency response.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A miniature sound generator, comprising:
a vibration system;
a magnetic circuit system including a permanent magnet accommodated in a magnetic bowl and a pole piece located on the permanent magnet,
a housing for accommodating and fixing the vibration system; wherein
the permanent magnet includes a first through-hole, the pole piece has a second through-hole, and the magnetic bowl includes a blind hole.

2. The miniature sound generator as described in claim 1, wherein the permanent magnet is located between the magnetic bowl and the pole piece, and the first through-hole is located between the second through-hole and the blind hole.

3. The miniature sound generator as described in claim 1, wherein a diameter of the second through-hole is greater than a diameter of the first through-hole.

4. The miniature sound generator as described in claim 1, wherein a diameter of the blind hole is not smaller than a diameter of the first through-hole.

5. The miniature sound generator as described in claim 1, wherein the first through-hole, the second through-hole and the blind hole are cylindrical, and the first through-hole, the second through-hole and the blind hole are coaxial with each other.

6. The miniature sound generator as described in claim 1, wherein the first through-hole, the second through-hole and the blind hole are different in shape, and central axis of the first through-hole, the second through-hole and the blind hole are coaxial with each other.

7. The miniature sound generator as described in claim 1, wherein the first through-hole and the second through-hole penetrate the permanent magnet and the pole piece along a thickness direction of the permanent magnet and the pole piece, and a depth of the blind hole is half of a thickness of the magnetic bowl.

8. The miniature sound generator as described in claim 1, wherein the first through-hole and the second through-hole are located respectively at a center of the permanent magnet and the pole piece.

9. A miniature sounder generator including:
a vibration system;
a magnetic circuit system including a permanent magnet and a pole piece accommodated in a magnetic bowl;
a housing for accommodating and fixing the vibration system and the magnetic circuit system therein; wherein
the permanent magnet and the pole piece are provided with a first cavity, and the magnetic bowl is provided with a blind hole.

10. The miniature sound generator as described in claim 9, wherein a second cavity is provided and located between the magnetic bowl and the permanent magnet for communicating with the first cavity.
